(19) United States
(12) Patent Application Publication
(10) Pub. No.: US 2012/0300029 A1
(43) Pub. Date: Nov. 29, 2012

(54) VIDEO PROCESSING DEVICE, TRANSMISSION DEVICE, STEREOSCOPIC VIDEO VIEWING SYSTEM, VIDEO PROCESSING METHOD, VIDEO PROCESSING PROGRAM AND INTEGRATED CIRCUIT

(76) Inventors: Takuji HIRAMOTO, Osaka (JP); Yuka Ozawa, Osaka (JP); Toru Kawaguchi, Osaka (JP); Hiroshi Yahata, Osaka (JP); Yasushi Uesaka, Hyogo (JP); Tomoki Ogawa, Osaka (JP)

(21) Appl. No.: 13/478,469

(22) Filed: May 23, 2012

Related U.S. Application Data
(60) Provisional application No. 61/489,825, filed on May 25, 2011.

(51) Int. Cl. H04N 13/04; H04N 13/00

(52) U.S. Cl. 348/43; 348/51; 348/E13.001; 348/E13.075

(57) ABSTRACT

A video processing device 21 receives a data broadcast and video data for 3D display, the video data having a display position and depth set according to objects therein displayed in 3D, and object information indicating the display position and depth for data broadcast images when displayed in 3D. A data broadcast processor 206 acquires position information indicating the display position from BML. An offset acquirer 207 acquires an offset value corresponding to the display position from the offset information. A right-view data broadcast image generator 208 and a left-view data broadcast image generator 209 generate respective right-view data broadcast images and left-view data broadcast images using the offset value so acquired.

This application claims benefit to the provisional U.S. Application 61/489,825 filed on May 25, 2011.

### TECHNICAL FIELD

The present invention relates to technology for 3D (stereoscopic) display of a data broadcast.

### BACKGROUND ART

Digital broadcasting involves a transmission device that outputs subtitles or still images, separate from video data, as a data broadcast, and a reception device that performs a process of overlaying the subtitles or still images of the received data broadcast on video data (see Non-Patent Literature 1).

In recent years, devices capable of 3D display are being developed for use with movies, digital broadcast programs, games, and so on that have been adapted for 3D. In coming years, the overlay of 3D programming with data broadcasts containing text or still images is expected to become more common as 3D digital broadcasting development proceeds.

### CITATION LIST

### Patent Literature

[Patent Literature 1]

ARIB-TR-B15 (Operational Guidelines for Digital Satellite Broadcasting)

### SUMMARY OF INVENTION

### Technical Problem

However, data broadcasts currently in use are created for overlay not on 3D programs but rather on ordinary 2D programs, and overlay on 3D programs is not anticipated. As such, when a conventional data broadcast is simply overlaid on a 3D program, the text or still images of the data broadcast are displayed behind stereoscopic objects included in the 3D program, resulting in images that are viewed as unnatural by the user. In consideration of the above problem, the present invention aims to provide a video processing device, a transmission device, a stereoscopic video viewing system, a video processing method, a video processing program, and an integrated circuit, each capable of displaying a 3D program and a data broadcast together as images comfortable for the user to view.

### Solution to Problem

To achieve the stated aim, one aspect of the present invention provides a video processing device receiving a data broadcast and video data for 3D display, and overlaying, for output, an image of the data broadcast on a video of the video data, the video data including depth information that indicates a display depth for the image of the data broadcast when displayed in 3D, the depth information being set according to a depth at which an object based on the video data is displayed in 3D, the video processing device comprising: an acquirer acquiring the display depth from the depth information included in the video data; and a generator generating a right-view image and a left-view image for displaying the image of the data broadcast in 3D at the display depth acquired by the acquirer.

### Advantageous Effects of Invention

According to the above, one aspect of the present invention provides a video processing device that enables data broadcast images, intended for display as overlaid on video data, to be displayed in 3D at a depth corresponding to the depth of 3D objects in the video data. This allows the user to more comfortably view the data broadcast with the 3D video.

### BRIEF DESCRIPTION OF DRAWINGS

FIGS. 1A, 1B, and 1C illustrate the outline of a stereoscopic video viewing system 1.

FIG. 2 illustrates the configuration of the stereoscopic video viewing system 1.

FIG. 3 is a block diagram of a broadcasting device 10.

FIGS. 4A through 4E describe an offset information generation method.

FIGS. 5A through 5E further describe the offset information generation method.

FIG. 6 indicates the data structure for offset information 170.

FIG. 7 indicates the data structure for BML 180.

FIG. 8 is a block diagram of a digital television 20.

FIGS. 9A and 9B describe a generation method for left-view data broadcast images and for right-view data broadcast images.

FIG. 10 illustrates overlaying 3D video data with a data broadcast.

FIG. 11 indicates the data broadcast and a 3D object as displayed on a display 22.

FIGS. 12A and 12B illustrate an LR display mode for the 3D video data.

FIGS. 13A and 13B illustrate an LL display mode for the 2D video data.

FIG. 14 is a flowchart indicating the operations of a video processing device 21 during a data broadcast display process.

FIG. 15 is a flowchart indicating the operations during a display mode setting process.

FIG. 16 is a flowchart indicating the operations during an offset value acquisition process.

### DESCRIPTION OF EMBODIMENTS

A stereoscopic video viewing system 1 serving as an Embodiment of the present invention is described below, with reference to the accompanying drawings.

### (1. Outline)

The following describes the process taken by the inventors to obtain the stereoscopic video viewing system 1, serving as the Embodiment of the present invention.

As discussed above, when text or the like from a data broadcast is displayed behind a 3D object included in a 3D program, the resulting video may be perceived as unnatural by the user. In order to avoid such situations, the receiver is required to perform 3D conversion when the data broadcast is displayed as overlaid on the 3D program.

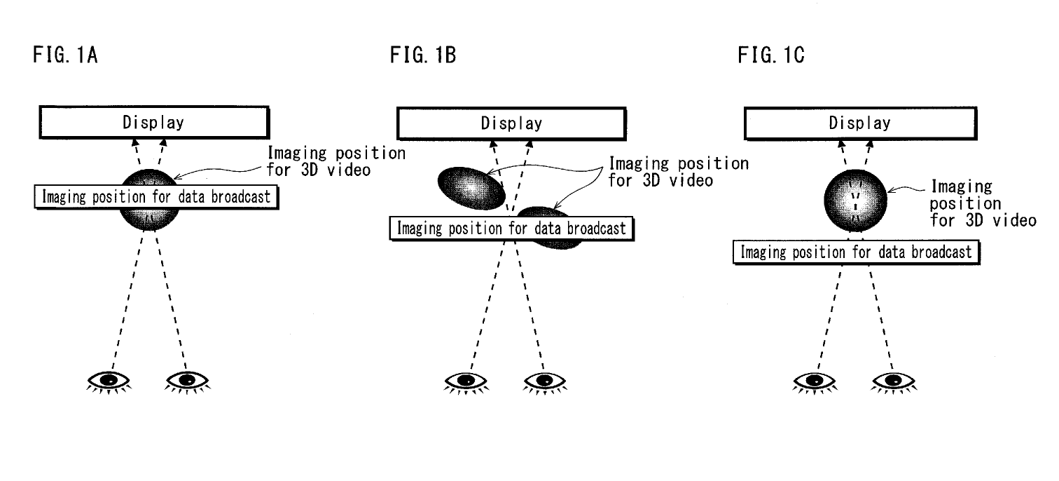

Incidentally, when 3D conversion is performed on the data broadcast by simply applying a predetermined fixed offset value in order to generate stereoscopic images, the imaging position of the 3D object included in the 3D program and the imaging position of the data broadcast may overlap, as shown in FIG. 1A. When the imaging position of the 3D object and the imaging position of the data broadcast overlap in this manner, interference occurs between the 3D object and the text or the like, resulting in images that are difficult for the user to view.

Also, as shown in FIG. 1B, when a plurality of 3D objects are included in the 3D program, each such 3D object has a different imaging position. Also, the imaging position of any given 3D object may vary by frame.

Thus, in order to constrain the interference between 3D objects and text or the like in the data broadcast, which occurs when the text of the data broadcast is displayed behind the 3D objects, the inventors arrived at a stereoscopic video viewing system that performs 3D conversion on the data broadcast such that the imaging position of the data broadcast is in front of the imaging position of the 3D objects, as shown in FIG. 1C.

### (2. Configuration)

The following describes the configuration of the stereoscopic video viewing system 1.

### (2-1. Stereoscopic Video Viewing System 1 Configuration)

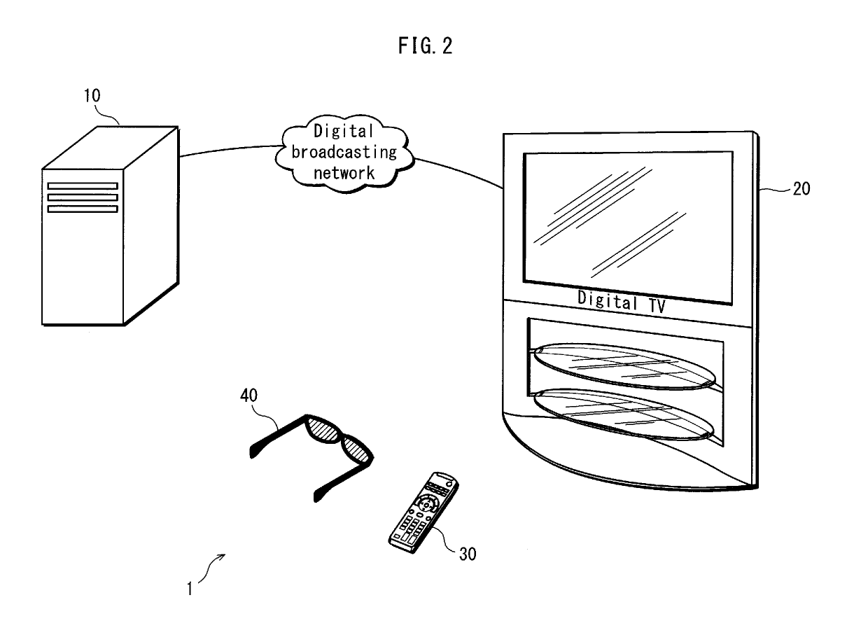

FIG. 2 illustrates the configuration of the stereoscopic video viewing system 1, which is the Embodiment of the present invention.

As shown, the stereoscopic video viewing system 1 includes a broadcasting device 10, a digital television 20, a remote control 30, and 3D glasses 40.

The broadcasting device 10 is a device installed at a digital broadcasting station, that transmits a broadcast stream, in which program content made up of audio data and 3D video is multiplexed with the data broadcast, over digital broadcast waves.

The digital television 20 is a 3D television capable of displaying 3D video, that receives the digital broadcast waves and extracts the broadcast stream from the digital broadcast waves so received. The broadcast stream is then split into audio data, 3D video data, and the data broadcast.

As described above, the overlay of 2D data broadcast with 3D video results in images that are difficult for the viewer to view. Thus, the digital television 20 is required to generate left-view images and right-view images from the images in the digital broadcast to achieve 3D broadcast.

The 3D video data received by the digital television 20 include offset information for generating the left-view images and the right-view images from the images in the data broadcast. An offset value is written in the offset information, indicating a number of pixels by which the images in the data broadcast are to be shifted to the left or to the right. The offset value is generated according to the imaging point of the 3D video data. The imaging point for objects in the data broadcast to be displayed in 3D is set so as to be in front of the imaging point for objects in the 3D video.

The digital television 20 extracts the offset information from the video data, then uses the offset information so extracted to generate a left-view image and a right-view image from each image included in the data broadcast. The digital television 20 then overlays the left-view image for the data broadcast onto the left-view video data of the 3D video, thus generating a left-view image for output. The digital television 20 also overlays the right-view image for the data broadcast onto the right-view video data of the 3D video, thus generating a right-view image for output. The digital television 20 outputs the right-view images and the left-view images in alternation on a display. By wearing the 3D glasses 40, the user is enabled to view the stereoscopic video and the data broadcast.

### (2-2. Broadcasting Device 10 Configuration)

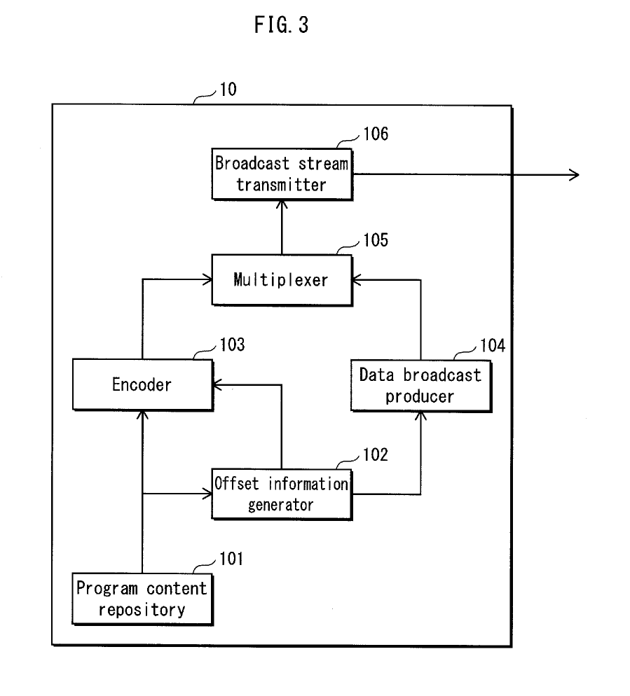

FIG. 3 is a block diagram illustrating the functional configuration of the broadcasting device 10.

As shown, the broadcasting device 10 includes a program content repository 101, an offset information generator 102, an encoder 103, a data broadcast producer 104, a multiplexer 105, and a broadcast stream transmitter 106.

The broadcasting device 10 includes a processor, RAM (Random Access Memory), ROM (Read-Only Memory), and a hard disk, none of which are diagrammed. The functional blocks of the broadcast device are realizable as hardware, or as programs stored in the ROM or on the hard disk and executed by the processor.

The program content repository 101 stores the 3D video data and audio data making up the program.

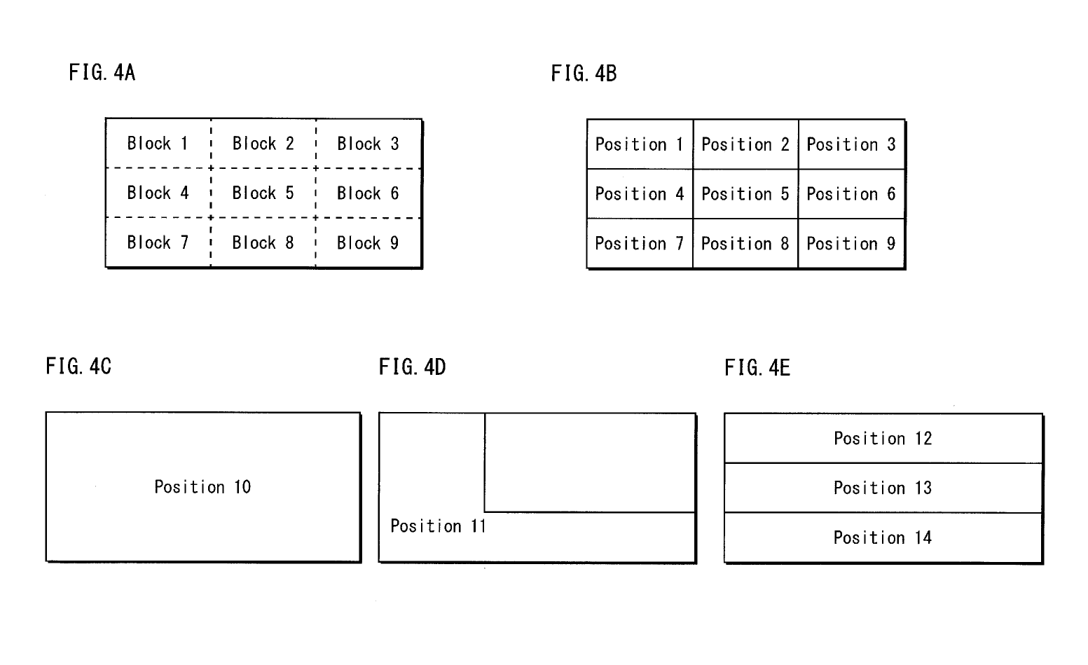

The offset information generator 102 reads the 3D video data stored in the program content repository 101 and generates the offset information for each frame of 3D video data so read. The offset information generation process is described with reference to FIGS. 4A through 4E, 5A through 5E, and 6.

As shown in FIG. 4A, the offset information generator 102 predefines positions 1 through 14, used when the plane on which the 3D video data are drawn is divided into nine regions termed blocks 1 through 9.

As shown in FIG. 4B, position 1 includes block 1. Position 2 includes block 2. Position 3 includes block 3. Position 4 includes block 4. Position 5 includes block 5. Position 6 includes block 6. Position 7 includes block 7. Position 8 includes block 8. Position 9 includes block 9. As shown in FIG. 4C, position 10 includes all blocks 1 through 9. As shown in FIG. 4D, position 11 includes blocks 1, 4, 7, 8, and 9. As shown in FIG. 4E, position 12 includes blocks 1, 2, and 3. Position 13 includes blocks 4, 5, and 6. Position 14 includes blocks 7, 8, and 9.

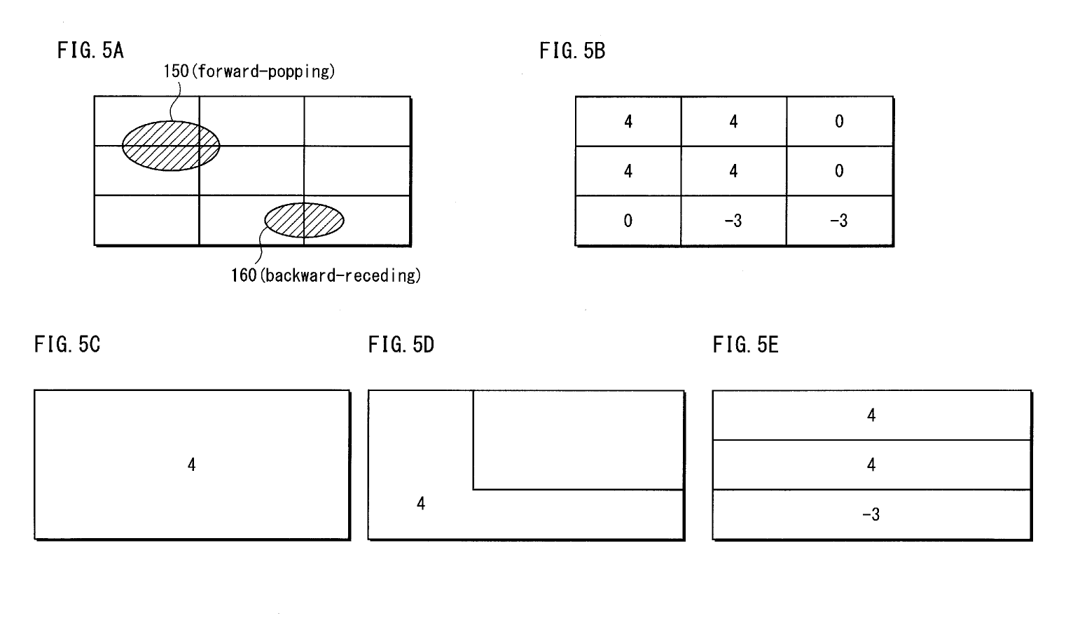

FIGS. 5A through 5E indicate the relationship between the depth of a 3D object included in the frame to the offset value in each region, given for a frame making up the 3D video data.

As shown in FIG. 5A, in this example, the frame includes a forward-popping object 150 and a backward-receding object 160. Object 150 has a depth of 4, expressed in terms of offset value, whereas object 160 has a depth of −3, also expressed in terms of offset value.

FIGS. 5B through 5E give the offset values at positions 1 through 14 in these circumstances. As shown in FIG. 5B, the offset value is 4 at positions 1, 2, 4, and 5, where object 150 is displayed, and is −3 at positions 8 and 9, where object 160 is displayed. The offset value is 0 at positions 3, 6, and 7, where neither object 150 nor object 160 are displayed. Also, as shown in FIGS. 5C and 5D, the offset value is 4, i.e., the greatest absolute value, at positions 10 and 11 where both objects 150 and 160 are displayed. As shown in FIG. 5E, the offset value is 4 at positions 12 and 13, where object 150 is displayed, and is −3 at position 14 where object 160 is displayed.

The offset information generator 102 determines the offset values used for 3D display of the data broadcast images, in conformity with the offset values of the 3D video indicated in FIGS. 5A through 5E. For example, in the present Embodiment, the offset values for the data broadcast images are found by adding 1 to the offset values of the 3D video data. The offset value for the data broadcast is 0 at any position where the offset value for the 3D video data is also 0.

By determining the offset values for the data broadcast images in this manner, the user is enabled to see the data broadcast as images projecting forward, in front of the 3D video.

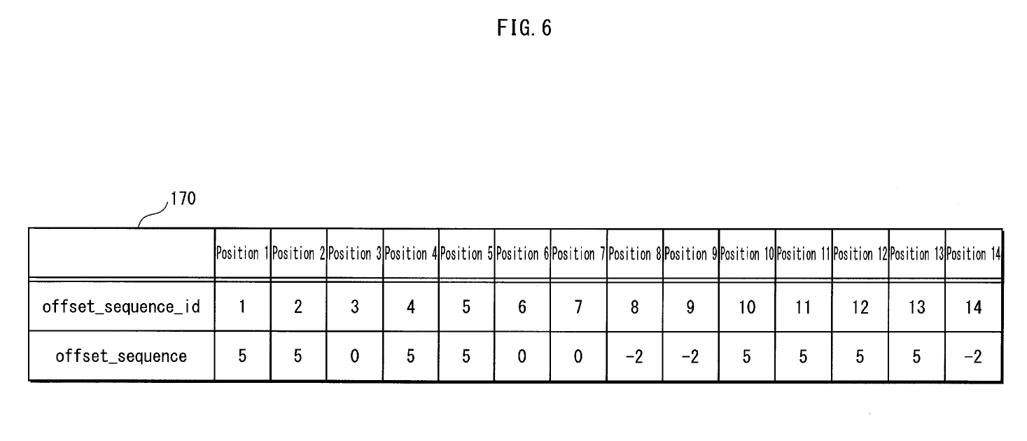

As shown in FIG. 6, the offset information generator 102 generates offset information 170 in the form of a table listing offset_sequence_id fields of information designating the positions and offset_sequence fields of information indicating the offset value at each position. The offset information 170 so generated is input to the encoder 103 and to the data broadcast producer 104. The offset information 170 here given is an example of depth information pertaining to the present invention.

The encoder 103 includes a video encoder and an audio encoder. The video encoder reads the 3D video data from the program content repository 101, and encodes the data using H.264 MVC (Multiview Video Coding) to obtain a video stream in the MPEG2-TS (Moving Picture Experts Group Transport Stream) format. The audio encoder reads the audio data from the program content repository 101 and encodes the data to obtain an audio stream in the MPEG2-TS format.

When the video encoder encodes the 3D video data and thus generates GOPs (Group Of Pictures), each GOP included in the H.264 MVC dependent view (compressed video data for one eye) of the 3D video data contains the offset information generated by the offset information generator 102.

The video stream and audio stream so encoded are input to the multiplexer.

The data broadcast producer 104 generates data for the data broadcast using BML (Broadcast Markup Language). The data so generated are input to the multiplexer 105.

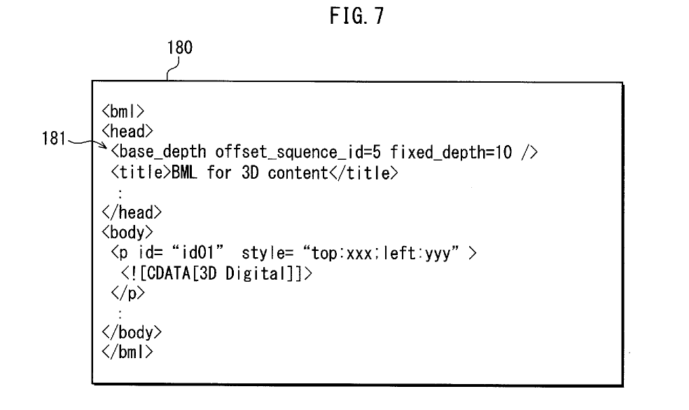

The sample BML 180 given in FIG. 7 is an example for data generated by the data broadcast producer 104 and described by BML. The string “3D Digital” is BML intended for display at position 5 (see FIG. 3B). Similarly, the BML 180 includes a base_depth element 181 serving as information for determining the depth of the images in the data broadcast (e.g., of the string “3D Digital”). The base_depth element 181 includes an offset_sequence_id attribute and a fixed_depth attribute.

The offset_sequence_id attribute is used to determine the display position for the image. When the string “3D Digital” is to be displayed at position 5 (see FIG. 3B), the data broadcast producer 104 acquires the value of the offset_sequence_id attribute, which is 5, corresponding to position 5, at which the string is to be displayed, from the 104 offset information 170 received from the offset information generator 102. The acquired value of 5 is then used as the value of the offset_sequence_id attribute in the base_depth element.

The fixed_depth attribute is an offset value for display at a fixed_depth, such that the depth of the data broadcast images does not change according to the depth of the video in the 3D video data. When notified of the maximum depth for objects included in all frames making up the 3D video data, the data broadcast producer 104 sets the fixed_depth attribute such that the offset value indicates a depth for the data broadcast images that is in front of this maximum depth. When not notified of the maximum depth, a predetermined value may be used as the value of the fixed_depth attribute. The fixed_depth attribute in the BML 180 is, for example, 10.

The multiplexer 105 multiplexes the video stream, the audio stream, the data marked up BML, and so on, to generate the MPEG2-TS stream. The MPEG2-TS stream so generated is then input to the broadcast stream transmitter 106.

The broadcast stream transmitter 106 outputs the MPEG2-TS stream generated by the multiplexer 105 on the digital broadcast waves.

### (2-3. Digital Television 20 Configuration)

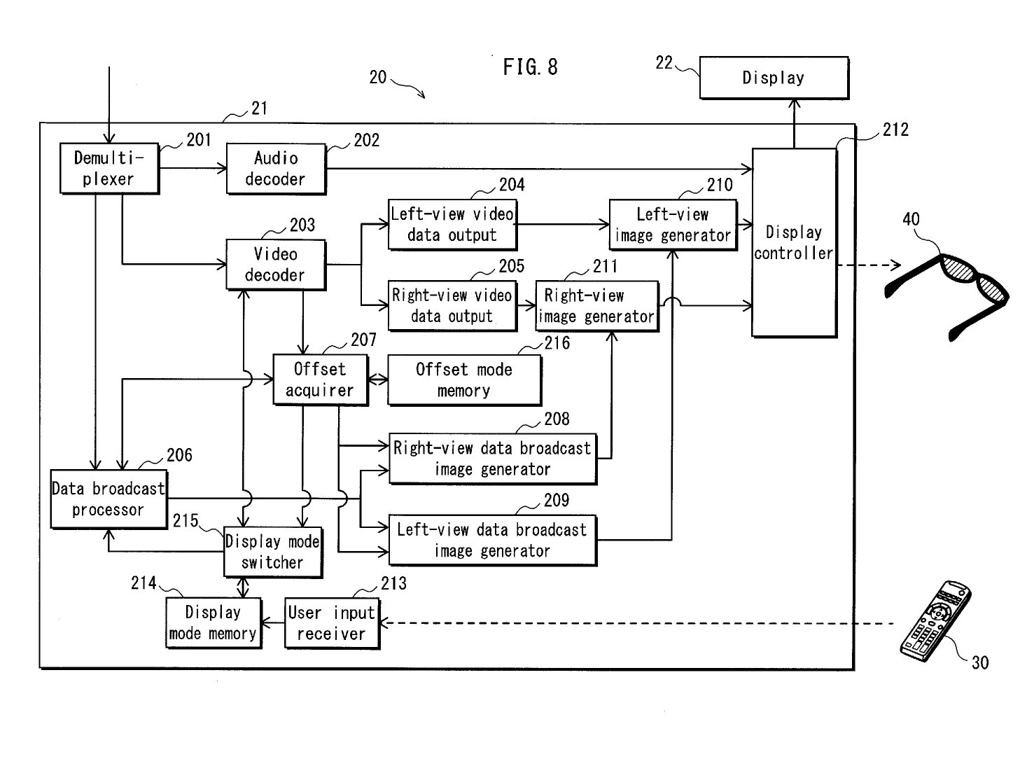

FIG. 8 is a block diagram illustrating the functional configuration of the digital television 20. As shown, the digital television 20 is made up of a video processing device 21 and a display 22.

The video processing device 21 further includes a demultiplexer 201, an audio decoder 202, a video decoder 203, a left-view video data output 204, a right-view video data output 205, a data broadcast processor 206, an offset acquirer 207, a right-view data broadcast image generator 208, a left-view broadcast image generator 209, a left-view image generator 210, a right-view image generator 211, a display controller 212, a user input receiver 213, a display mode memory 214, a display mode switcher 215, and an offset mode memory 216.

The video processing device 21 includes a processor, RAM, ROM, and a hard disk, none of which are diagrammed. Also, the functional blocks of the video processing device 21 may be configured as hardware, or may be realized as computer programs stored in ROM or on the hard disk and executed by the processor.

The demultiplexer acquires the MPEG2-TS stream, received over a digital broadcasting network, and outputs the audio stream, the video stream, and the data marked up in BML, each being multiplexed in the MPEG2-TS stream. The demultiplexer 201 passes the audio stream to the audio decoder 202, passes the video stream to the video decoder 203, and passes the data marked up in BML to the data broadcast processor 206.

The audio decoder 202 acquires and decodes the audio stream. Upon decoding, the audio signal is input to the display controller 212.

The video decoder 203 acquires and decodes the video stream. The video stream is made up of the 3D video data, compression-coded in conformity with H.264 MVC. Upon decoding the video stream, the video decoder 203 decodes the video data into two streams, one for the left view and one for the right view.

The video decoder 203 acquires the display mode for the 3D video data from the display mode switcher 215. The display mode for the 3D video data is one of an LR display mode (Left view-Right view) and an LL display mode (Left view-Left view).

In the LR display mode, the video decoder 203 outputs the decoded video data for the left view to the left-view video data output 204, and outputs the decoded video data for the right view to the right-view video data output 205. In the LL display mode, the video decoder 203 outputs the decoded video data for the left view to the left-view video data output 204 and to the right-view video data output 205. The details of the LR display mode and the LL display mode are described later.

The left-view video data output 204 and the right-view video data output 205 each control the output timing for the video data respectively acquired thereby from the video decoder 203, so as to output the left-view video data and the right-view video data in alternation to the left-view image generator 210 and the right-view image generator 211.

Upon acquiring the data extracted by the demultiplexer 201, the data broadcast processor 206 parses the data so acquired to perform a drawing process. The picture data thus generated are picture data for 2D display.

For example, upon acquiring the BML 170 indicated FIG. 7, the data broadcast processor 206 uses the plane memory to draw text data reading “3D Digital” at the position defined top=xxx, left=yyy. The coordinates of this position are given for a situation where the top edge of the screen is defined as top=0 and the left edge thereof is defined as left=0.

The data broadcast processor 206 acquires the display mode for the data broadcast from the display mode switcher 215. The display mode for the data broadcast is one of the LR display mode and the LL display mode.

In the LR display mode, the data broadcast processor 206 outputs the picture data for 2D display, with 3D display instructions, to the right-view data broadcast image generator 208 and to the left-view data broadcast image generator 209. In the LL display mode, the data broadcast processor 206 outputs the picture data for 2D display, with 2D display instructions, to the right-view data broadcast image generator 208 and to the left-view data broadcast image generator 209.

The data broadcast processor 206 also outputs the base_depth element included in the BML to the offset acquirer 207.

The offset acquirer 207 extracts the offset information from the GOPs acquired by the video decoder 203 decoding the video stream. The offset acquirer 207 also acquires the base_depth element from the data broadcast processor 206. Further, the offset acquirer 207 reads the offset mode stored in the offset mode memory 216.

The offset acquirer 207 uses the offset information, the base_depth element, and the offset mode to acquire the offset value, which is parallax information for 3D display of the data broadcast. The right-view data broadcast image generator 208 and the left-view data broadcast image generator 209 are notified of the offset value so acquired.

As a specific example, the offset acquirer 207 is here described as acquiring the offset information 170 shown in FIG. 6 and the base_depth element 181 given in FIG. 7.

When the offset mode read from the offset mode memory 216 is variable, the offset acquirer 207 reads the value of the offset_sequence_id attribute included in the base_depth element 181. Here, the value is 5. As for the offset value, the offset acquirer 207 acquires the value of the offset_sequence field associated with the value of the offset_sequence_id attribute, which is 5, from the offset information 170. In this example, the offset value is 5.

When the offset mode read from the offset mode memory 216 is fixed, the offset acquirer 207 acquires the value of the fixed_depth attribute from the base_depth element 181, to be used as the offset value. In this example, the offset value is 10.

The right-view data broadcast image generator 208 and the left-view data broadcast image generator 209 receive the picture data for 2D display from the data broadcast processor 206, along with an instruction for one of 3D display and 2D display. The right-view data broadcast image generator 208 and the left-view data broadcast image generator 209 also receive the offset value from the offset acquirer 207.

Upon receiving a 2D display instruction, the right-view data broadcast image generator 208 and the left-view data broadcast image generator 209 output the picture data for 2D display received from the data broadcast processor 206 to the left-view image generator 210 and the right-view image generator 211.

Upon receiving a 3D display instruction, the right-view data broadcast image generator 208 generates right-view data broadcast images, and the left-view data broadcast image generator 209 generates left-view data broadcast images.

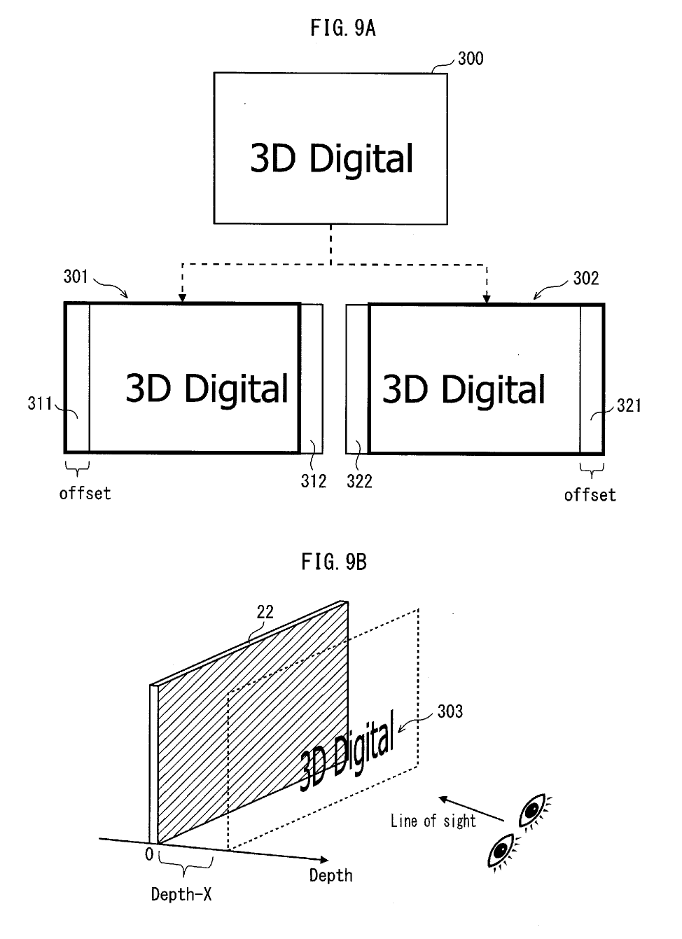

The following describes the generation process for the right-view data broadcast images and the left-view data broadcast images, with reference to FIG. 9A.

The right-view data broadcast image generator 208 and the left-view data broadcast image generator 209 receive the picture data 300, and receive the offset value from the offset acquirer 207.

The left-view data broadcast image generator 209 shifts the picture data 300 to the right by the number of pixels indicated in the offset value, as notified, thus generating a transparent area 311 on the left side, then cuts a right-edge area 312 to generate the left-view data broadcast image 301.

The right-view data broadcast image generator 208 shifts the picture data 300 to the left by the number of pixels indicated in the offset value, as notified, thus generating a transparent area 321 on the right side, then cuts a left-edge area 322 to generate the right-view data broadcast image 302.

FIG. 9B illustrates the manner in which stereoscopic video is played back through offset control as shown in FIG. 9A. Plane 303, on which the images for 3D display of the data broadcast are drawn, is at Depth X. Consequently, the user sees the string “3D Digital” as projecting forward, in front of the display 22 by Depth X.

The left-view data broadcast image generator 209 outputs the left-view data broadcast images so generated to the left-view image generator 210, and the right-view data broadcast image generator 208 outputs the right-view data broadcast images so generated to the right-view image generator 211.

The left-view image generator 210 receives the left-view data broadcast images from the left-view data broadcast image generator 209. The left-view image generator 210 also sequentially receives decoded left-view video data from the left-view video data output 204. The left-view image generator 210 overlays the left-view data broadcast images on the left-view video data to generate the left-view image. Each left-view image so generated is then input to the display controller 212.

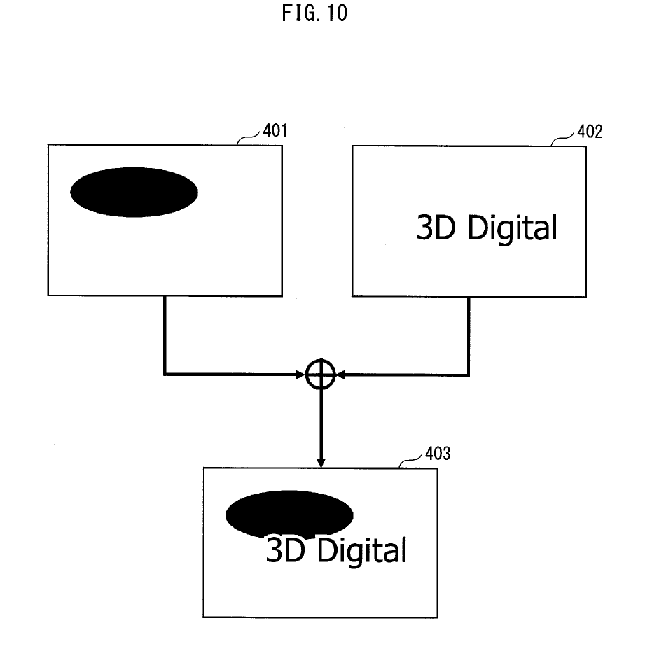

For example, as shown in FIG. 10, the left-view image generator 210 uses a plane memory intended for drawing one screen of the left-view video data to draw a left-view video plane 401. The left-view image generator 210 also uses a plane memory intended for drawing one screen of video included in the data broadcast to draw a left-view data broadcast plane 402. The left-view video plane 401 and the left-view data broadcast plane 402 are then overlaid to generate left-view image 403, in which the objects included in the 3D video data and the string “3D Digital” from the data broadcast are combined.

Similarly, the right-view image generator 211 receives the right-view data broadcast images from the right-view data broadcast image generator 208. The right-view image generator 211 also sequentially receives decoded right-view video data from the right-view video data output 205. The right-view image generator 211 overlays the right-view data broadcast images on the right-view video data to generate the right-view image. Each right-view image so generated is then input to the display controller 212.

The display controller 212 receives the left-view images and the right-view images in alternation from the left-view image generator 210 and the right-view image generator 211, then outputs the left-view images and the right-view images so received to the display 22. When the image currently being output is a left-view image, the display controller 212 notifies the 3D glasses 40 being worn by the user that the left-view image is being displayed. Conversely, when the image currently being output is a right-view image, the display controller 212 notifies the 3D glasses 40 being worn by the user that the right-view image is being displayed.

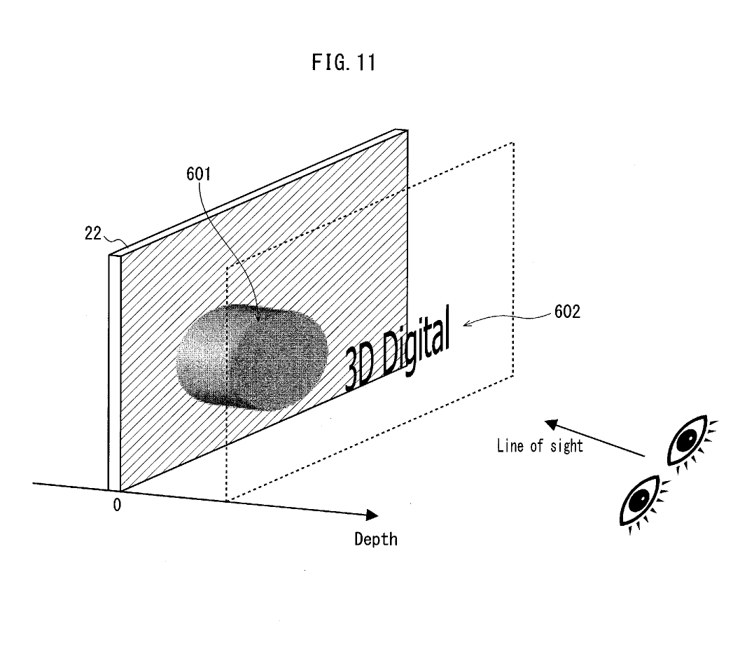

When the display 22 is displaying a left-view image, the right lens of the 3D glasses 40 is covered by a liquid crystal shutter such that the user only sees the left-view image with the left eye. Conversely, when the display 22 is displaying a right-view image, the left lens of the 3D glasses 40 is covered by a liquid crystal shutter such that the user only sees the right-view image with the right eye. Through such display control, the user is shown an image such as that of FIG. 11. As shown in FIG. 11, object 601 included in the 3D video data is viewed as projecting forward, in front of the display 22. Furthermore, string 602 of the data broadcast is viewed as projecting forward farther in front.

Additionally, in synchronicity with the screens output to the display 22, the display controller 212 outputs the audio signal received from the audio decoder to speakers (not diagrammed) within the display 22.

The user input receiver 213 receives the display mode for the 3D video from the remote control 30, as input by the user operating the remote control 30. The user input receiver 213 also records the display mode for the 3D video so received in the display mode memory 214.

The display mode memory 214 is non-volatile memory for storing the display mode for the 3D video input by the user.

The display mode switcher 215 sets the display mode for the 3D video and for the data broadcast. The display mode switcher 215 also notifies the video decoder 203 of the display mode for the 3D video data. The display mode switcher 215 also notifies the data broadcast processor 206 of the display mode for the data broadcast. The details of the display mode setting process are described later.

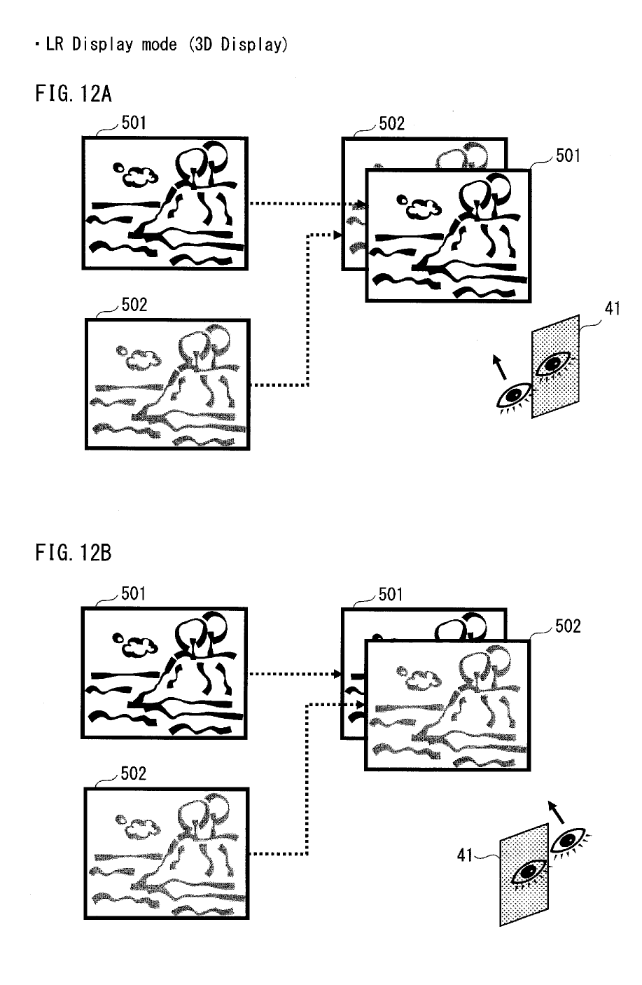

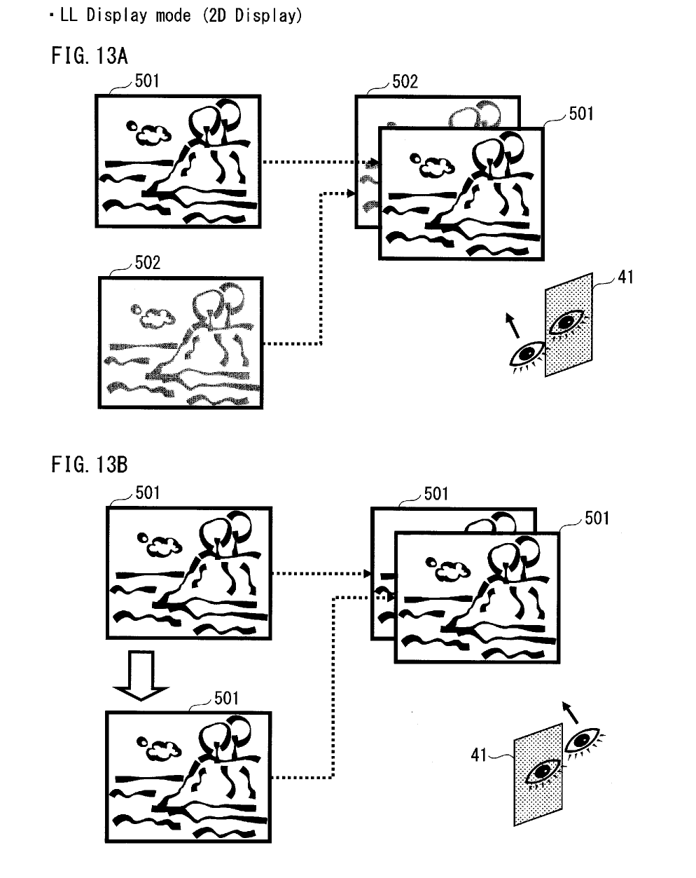

The display modes are described below with reference to FIGS. 12A, 12B, 13A, and 13B. Although this explanation is given for the example of the display mode for the 3D video data, the same applies to the display mode for the data broadcast.

As previously noted, the display mode is one of the LR display mode and the LL display mode. The LR display mode is for displaying the 3D video data in 3D, while the LL display mode is for displaying the 3D video data in 2D.

FIGS. 12A and 12B illustrate the LR display mode (3D display).

In the LR display mode, the video decoder 203 outputs the decoded left-view video data 501 to the left-view video data output 204, and outputs the decoded right-view video data 502 to the right-view video data output 205. The left-view video data 501 and the right-view video data 502 are images having parallax.

Then, the left-view video data 501 and the right-view video data 502 are output in alternation through the display controller 212 to the display 22.

As shown in FIG. 12A, when the left-view video data 501 are displayed on the display 22, the right lens of the 3D glasses 40 is covered by a liquid crystal shutter 41, such that the user only sees the left-view video data 501 with the left eye.

Similarly, as shown in FIG. 12B, when the right-view video data 502 are displayed on the display 22, the left lens of the 3D glasses 40 is covered by the liquid crystal shutter 41, such that the user only sees the right-view video data 501 with the right eye.

As such, in the LR display mode, 3D display is realized by showing the parallax images of the left-view video data 501 and the right-view video data 502 in alternation.

FIGS. 13A and 13B illustrate the LL display mode (2D display).

In the LL display mode, the video decoder 203 uses the decoded left-view video data 501 as the right-view video data. That is, the video decoder 203 outputs the decoded left-view video data 501 to the left-view video data output 204 and to the right-view video data output 205.

Then, the left-view video data 501 and right-view video data 501, being identical and thus without parallax, are output in alternation through the display controller 212 to the display 22.

As shown in FIG. 13A, when the left-view video data 501 are displayed on the display 22, the right lens of the 3D glasses 40 is covered by a liquid crystal shutter 41, such that the user only sees the left-view video data 501 with the left eye.

Then, as shown in FIG. 13B, when the identical right-view video data 501 are displayed on the display 22, the left lens of the 3D glasses 40 is covered by the liquid crystal shutter 41, such that the user only sees the right-view video data 501 with the right eye.

Accordingly, in the LL display mode, 2D display is realized by showing identical video data without parallax in alternation while the user wears the 3D glasses 40.

The offset mode memory 216 is non-volatile memory for storing the offset mode, in which a method for determining the offset value of the parallax information used for 3D display of the data broadcast is executed. The offset mode is one of variable and fixed. The offset mode is input by the user through the user input receiver 213.

In the variable offset mode, the value of the offset_sequence included in the offset information received along with the 3D video data is used as the offset value. As previously noted, the offset information received with the 3D video data is included in each GOP. That is, the offset information is updatable for each GOP. Therefore, although the BML is not updated, when the offset_sequence included in the offset information is variable, e.g., when the depth for the 3D object 601 described with reference to FIG. 11 is variable, the depth of string 602 reading “3D Digital” correspondingly varies.

On the other hand, in the fixed offset mode, the value of the fixed_depth attribute included in the BML is used as the offset value. The fixed_depth attribute may be updatable at the BML level, but is not associated with the 3D video data. Therefore, the effect by which the depth of images in the data broadcast varies according to the varying depth of the 3D video data is cancelled. However, depending on the user, varying the depth of the text in the data broadcast may make the text harder to view. In such circumstances, the user need only set the offset mode to fixed.

### (3. Operations)

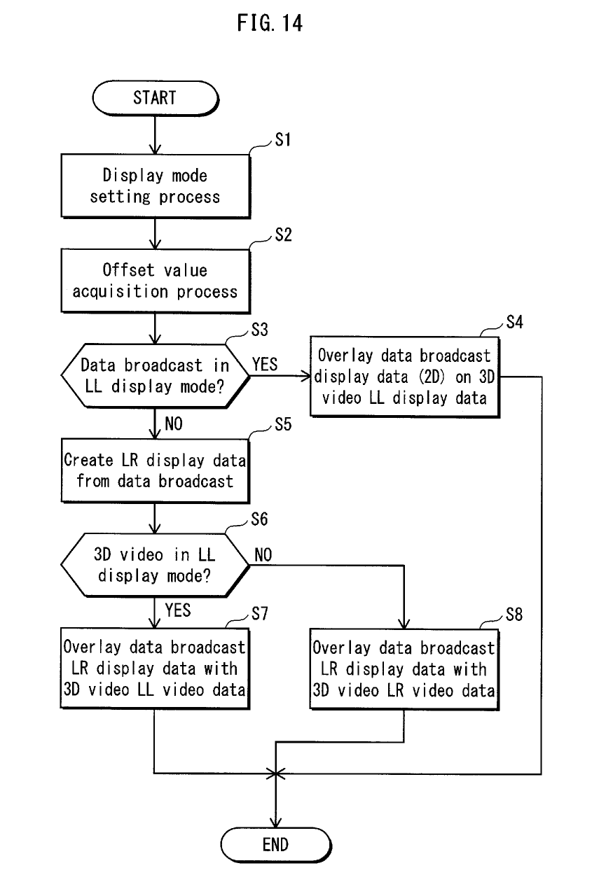

The following describes the operations of the video processing device 21 with reference to the flowcharts of FIGS. 14-16.

### (3-1. Data Broadcast Display Operations)

FIG. 14 is a flowchart indicating the operations of the video processing device 21 during a data broadcast display process. In the flowchart, the term “data broadcast LR display data” denotes the above-described left-view data broadcast images and right-view data broadcast images, in combination. Also, the term “3D video LR video data” denotes the above-described left-view video data and right-view video data, in combination.

The display mode switcher 215 sets the display mode for the 3D video and for the data broadcast (step S1). The details of step S1 are described later.

The offset acquirer 207 acquires the offset value, which is parallax information for displaying the data broadcast in 3D (step S2). The details of step S2 are described later.

The data broadcast processor 206 determines whether the display mode for the data broadcast set by the display mode switcher 215 during step S1 is the LL display mode or the LR display mode.

When the display mode for the data broadcast is the LL display mode (YES in step S3), the data broadcast processor 206 notifies the right-view data broadcast image generator 208 and the left-view data broadcast image generator 209 to such effect. The right-view data broadcast image generator 208 and the left-view data broadcast image generator 209 output the picture data received from the data broadcast processor 206 as-is, prior to 3D conversion, to the right-view image generator 211 and the left-view image generator 210.

When the display mode for the data broadcast is the LL display mode, the display mode for the 3D video data is also the LL display mode. Thus, the video decoder 203 outputs the left-view video data to the left-view video data output 204 and to the right-view video data output 205, for use in 2D display of the video data.

The left-view image generator 210 and the right-view image generator 211 then both overlay the data broadcast picture data onto the video data for 2D display (step S4). As a result, the 3D video and the data broadcast are displayed in 2D through the display controller 212 on the display 22.

The reason is that, when the data broadcast is in the LL display mode (i.e., 2D display), then overlaying the data broadcast for 2D display on 3D video data would result in text and the like from the data broadcast being displayed behind 3D objects, making the screen difficult for the user to view. Thus, when the data broadcast is in the LL display mode, the 3D video data are also displayed in 3D to show the user a screen that is easy to view.

When the display mode for the data broadcast is the LR display mode (NO in step S3), the right-view data broadcast image generator 208 and the left-view data broadcast image generator 209 use the offset value acquired in step S2 by the offset acquirer 207 to respectively generate right-view data broadcast images and left-view data broadcast images from the data broadcast picture data, as shown in FIGS. 9A and 9B (step S5). The right-view data broadcast image generator 208 then outputs the right-view data broadcast images to the right-view image generator 211, and the left-view data broadcast image generator 209 outputs the left-view data broadcast images to the left-view image generator 210.

Next, the data broadcast processor 206 acquires the display mode for the 3D video from the display mode switcher 215 and determines whether the display mode is the LL display mode or the LR display mode (step S6).

When the display mode for the 3D video data is the LL display mode (YES in step S6), the video decoder 203 outputs the left-view video data to the left-view video data output 204 and the right-view video data output 205 for use as video data for 2D display. The left-view video data output 204 and the right-view video data output 205 output the left-view video data, i.e., the video data for 2D display, to the right-view image generator 211 and to the left-view image generator 210 according to predetermined timing.

The left-view image generator 210 overlays the left-view data broadcast images onto the video data for 2D display. Similarly, the right-view image generator 211 overlays the right-view data broadcast images onto the video data for 2D display (step S7). As a result, the 3D video is displayed in 2D through the display controller 212 on the display 22, while the data broadcast is displayed in 3D.

When the display mode for the 3D video data is the LR display mode (NO in step S6), the video decoder 203 outputs the left-view video data to the left-view video data output 204 and outputs the right-view video data to the right-view video data output 205. The left-view video data output 204 and the right-view video data output 205 respectively output the left-view video data to the left-view image generator 210 and the right-view video data to the right-view image generator 211, in accordance with predetermined timing.

The left-view image generator 210 overlays the left-view data broadcast images onto the left-view video data for 3D display. Similarly, the right-view image generator 211 overlays the right-view data broadcast images onto the right-view video data for 3D display (step S8). As a result, the 3D video and the data broadcast are displayed in 3D through the display controller 212 on the display 22.

### (3-2. Display Mode Setting Operations)

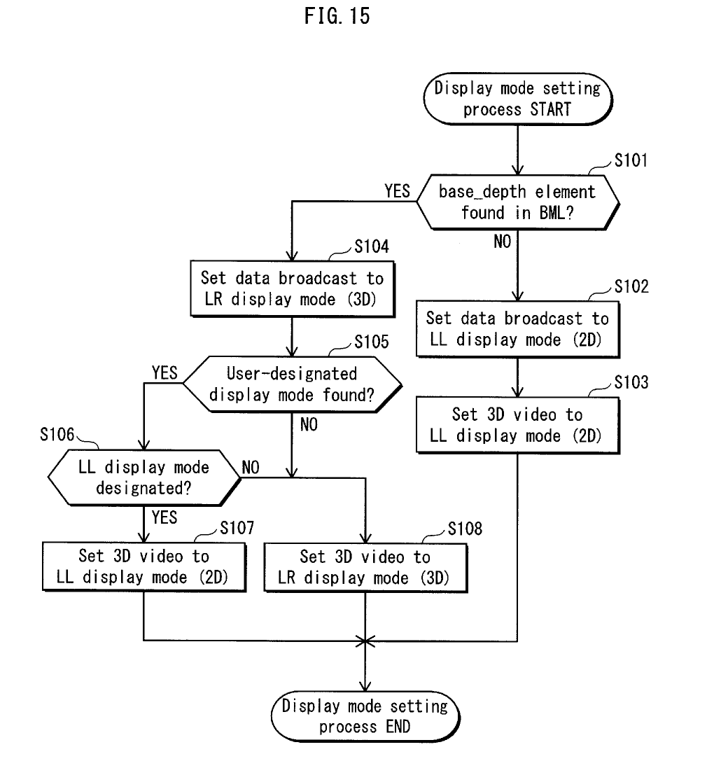

FIG. 15 is a flowchart indicating the operations of the display mode switcher during the display mode setting process. The operations here described are the details of step S1 from FIG. 14.

The display mode switcher 215 acquires the base_depth element from the BML acquired by the data broadcast processor 206.

When no base_depth element is found in the BML (NO in step S101), the display mode switcher 215 sets the display mode for the data broadcast to the LL display mode (step S102).

Also, as described above, when the data broadcast is in the LL display mode such that the data broadcast is displayed in 2D, then the 3D video data is beneficially also displayed in 2D. Thus, the display mode switcher 215 sets the display mode for the 3D video data to the LL display mode (step S103).

When the base_depth element is found in the BML (YES in step S101), the display mode switcher 215 sets the display mode for the data broadcast to the LR display mode (step S104).

Next, the display mode switcher 215 determines whether or not a display mode designated in advance by the user is stored in the display mode memory 214 (step S105).

When the user has not designated a display mode (NO in step S105), the display mode switcher 215 sets the display mode for the 3D video data to the LR display mode (step S108).

When the user has designated a display mode (YES in step S105), the display mode switcher 215 determines whether the display mode so stored is the LL display mode or the LR display mode (step S106).

When the user has designated the LL display mode (YES in step S106), the display mode switcher 215 sets the display mode for the 3D video data to the LL display mode (step S107).

Conversely, when the user has designated the LR display mode (NO in step S106), the display mode switcher 215 sets the display mode for the 3D video data to the LR display mode (step S108).

### (3-3. Offset Value Acquisition Operations)

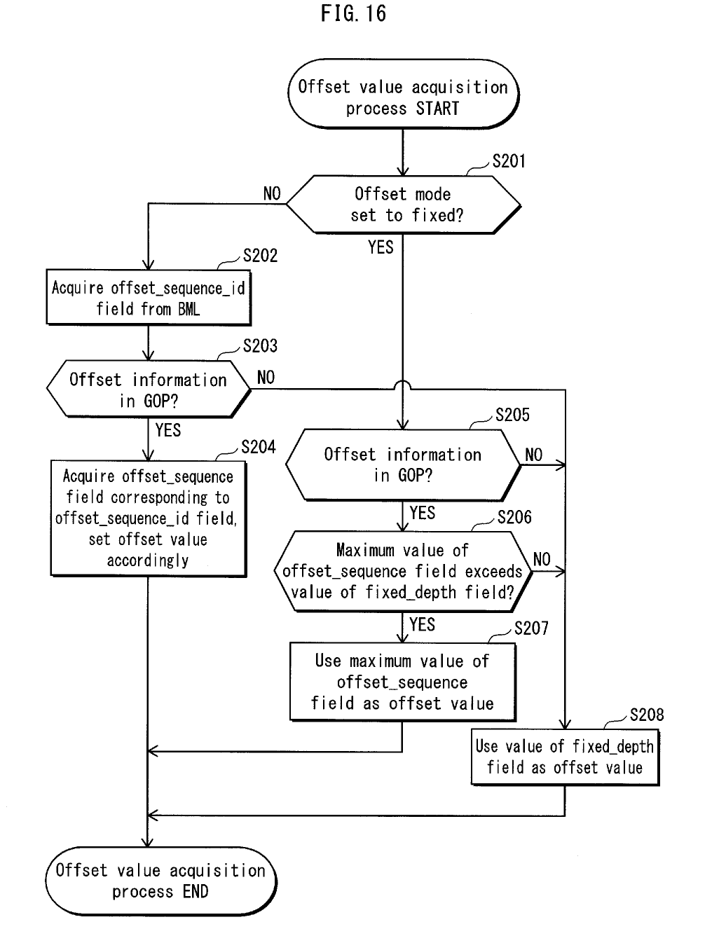

FIG. 16 is a flowchart indicating the operations of the offset acquirer 207 during the offset value acquisition process. The operations here described are the details of step S2 from FIG. 1.

The offset acquirer 207 determines whether the offset mode stored in the offset mode memory 216 is fixed or variable (step S201).

When the offset mode is variable (NO in step S201), the offset acquirer 207 acquires the offset_sequence_id attribute included in the base_depth element from the BML analyzed by the data broadcast processor 206 (step S202).

Next, the offset acquirer 207 acquires the data in the user data area of each GOP decoded by the video decoder 203, and determines whether or not offset information is included in the GOP (step S203).

When no offset information is included in the GOP (NO in step S203), the offset acquirer 207 acquires the value of the fixed_depth field from the base_depth element. Then, the offset acquirer 207 makes the value of the fixed_depth attribute into the offset value (step S208).

When the offset information is included in the GOP (YES in step S203), the offset acquirer 207 acquires the value of the offset_sequence field associated with the offset_sequence_id attribute acquired in step S202 from the offset information. Then, the offset acquirer 207 makes the value of the offset_sequence field into the offset value (step S204).

Conversely, when the offset mode is fixed (YES in step S201), the offset acquirer 207 acquires the data in the user data area of each GOP decoded by the video decoder 203, and determines whether or not offset information is written in the GOP (step S205).

When no offset information is included in the GOP (NO in step S205), the offset acquirer 207 acquires the value of the fixed_depth attribute from the base_depth element. Then, the offset acquirer 207 makes the value of the fixed_depth attribute into the offset value (step S208).

When the offset information is included in the GOP (YES in step S205), the offset acquirer 207 reads all values in the offset_sequence field from the offset information. The offset acquirer 207 also acquires the value of the fixed_depth attribute from the base_depth element in the BML analyzed by the data broadcast processor 206.

The offset acquirer 207 determines whether or not the maximum value in the offset_sequence field exceeds the value of the fixed_depth attribute (step S206).

When the maximum value in the offset_sequence field does not exceed the value of the fixed_depth attribute (NO in step S206), the offset acquirer 207 makes the value in the fixed_depth attribute into the offset value (step S208).

When the maximum value in the offset_sequence field exceeds the value of the fixed_depth attribute (YES in step S206), using the value of the fixed_depth attribute as the offset value is likely to lead to interference between objects in the 3D video data and objects in the data broadcast. Thus, when the maximum value in the offset_sequence field exceeds the value of the fixed_depth attribute, the offset acquirer 207 makes the maximum value of the offset_sequence field into the offset value (step S207).

### (4. Variations)

The above describes an Embodiment of a stereoscopic video viewing system pertaining to the present invention. However, the stereoscopic video viewing system so described is intended as an example, and the following variations are applicable thereto. Naturally, the stereoscopic video viewing system is not limited to the specific description provided in the Embodiment of the present invention.

(1) In the above-described Embodiment, the base_depth element is added to the BML, and the 3D display of the data broadcast is controlled using this base_depth element. Accordingly, 3D display can be controlled at the BML level.

However, a base_depth element may also be added to the SI (Service Information) or the PSI (Program Specific Information). In such circumstances, 3D display can be controlled at the program level. A base_depth element may also be added to the private region of the DII (Download Info Indication). In such circumstances, 3D display can be controlled at the module level.

(2) In the above-described Embodiment, the video processing device 21 is configured to receive 3D video transmitted from the broadcasting device 10. However, the video processing device 21 may also be configured to receive 2D video as well as 3D video. In such circumstances, the video processing device 21 may carry out the above-described 3D conversion process for the data broadcast upon detecting that the received program is 3D video. The video processing device 21 may be configured to ignore the base_depth element in the BML and display the data broadcast in 2D as long as 2D video is received.
(3) In the above-described Embodiment, the offset information is stored in the GOPs of the MPEG2-TS stream. However, the offset information is not limited to being stored in the GOPs, and may also be stored in the SI.

In such circumstances, the offset information generator 102 of the broadcasting device 10 inputs the generated offset information to the multiplexer 105 and not to the encoder 103.

(4) In the above-described Embodiment, the offset information is stored in the GOPs of the MPEG2-TS stream and transmitted by the broadcasting device 10.

However, the video processing device 21 may also perform 3D conversion on the data broadcast despite the offset information not being stored in the GOPs of the received 3D video data.

In such circumstances, the offset acquirer 207 acquires the left-view video data and the right-view video data from the video decoder 203. Then, the offset acquirer 207 extracts the parallax for the 3D object included in the left-view video data and the right-view video data. The offset acquirer 207 also generates the offset value to be used in the 3D conversion process for the data broadcast in accordance with the 3D object parallax, such that the data broadcast image appears to project forward in front of the 3D object.

That is, one aspect of the present invention provides a video processing device receiving a data broadcast and video data for 3D display, and overlaying, for output, an image of the data broadcast on a video of the video data, the video data including depth information that indicates a display depth for the image of the data broadcast when displayed in 3D, the depth information being set according to a depth at which an object based on the video data is displayed in 3D, the video processing device comprising: an acquirer acquiring the display depth from the depth information included in the video data; and a generator generating a right-view image and a left-view image for displaying the image of the data broadcast in 3D at the display depth acquired by the acquirer

(5) In the above-described Embodiment, the base_depth element is added to the BML. However, no limitation is intended. Information corresponding to the base_depth element may also be added to a style sheet.
(6) In the above-described Embodiment, the display mode switcher 215 of the video processing device 21 is configured to determine whether the 3D video data are to be displayed in the LR display mode or in the LL display mode. However, a control attribute indicating whether the 3D video data are to be displayed in the LR display mode or in the LL display mode may also be added to the BML.

For example, a mode_{—}3d attribute may be added as a control attribute to the base_depth element of the BML. When the mode_{—}3d attribute has a value of 00, then control by the video processing device 21 is designated, as explained in the above Embodiment. When the mode_{—}3d attribute has a value of 01, control is not performed by the video processing device 21 and the LL display mode may be forced for the 3D video data.

(7) In the above-described Embodiment, and as shown in FIG. 6, the offset information 170 indicates the depth of an object in the data broadcast and includes 14 offset_sequence fields corresponding to positions 1 through 14. However, no limitation is intended regarding this data structure for the offset information in the present invention. For example, nine offset_sequence fields corresponding to positions 1 through 9 may also be used.

This is possible because the values of the offset_sequence fields for each of data broadcast object display positions 10 through 14 can be calculated using the values of the offset_sequence fields for positions 1 through 9.

However, the data broadcast generally occurs at commonly-used regions of the screen. For example, position 10 corresponds to full-screen display, position 11 corresponds to L-shaped display, and positions 12, 13, and 14 each correspond to banner display.

Thus, as shown in FIGS. 4A through 4E, a plurality of blocks are combined to predefine positions 10 through 14, and as shown in FIG. 6, an offset_sequence field corresponding to each position 10 though 14 is stored in the offset information 170 in advance. This enables the offset acquirer 207 to simply set the offset value without needing to reference the offset_sequence field for each region.

In the above-described Embodiment, the picture plane is divided into nine parts to define positions 1 through 14. However, no limitation is intended regarding the division. New positions different from positions 1 through 14 may also be defined without dividing the screen according to the video data.

(8) In the above-described Embodiment, when the 3D video data are displayed in the LL display mode, 2D video is achieved by using the left-view video data. However, this configuration is not a strict requirement. While the left-view video data are commonly used when the 3D video data are displayed in the LL display mode, 3D display may, of course, also be achieved using the right-view video data.
(9) In the above-described Embodiment, the display mode memory 214 is configured to store the display mode for the 3D video data as designated by the user. However, the display mode memory 214 is not limited to storing the display mode designated by the user. When information designating the display mode for the 3D video data is included in the BML, the display mode memory 214 may store this information, and may similarly store information associating a category of 3D video data (e.g., a program content category) to a display mode designation.
(10) In the above-described Embodiment, the offset mode memory 216 stores the offset mode received in advance by the user input receiver 213, and the offset acquirer 207 determines and acquires the offset value in accordance with the offset mode stored in the offset mode memory 216.

However, when the display mode for the 3D video is the LL display mode (2D display) and the display mode for the data broadcast is the LR display mode (3D display), then the offset acquirer 207 may force a switch of the offset mode stored in the offset mode memory 216 to fixed.

When the 3D video data are displayed in 2D, the offset value for the data broadcast is unlikely to require a frame-by-frame change using the offset information. Thus, when the 3D video data are displayed in 2D, a change of the offset mode may be made to fixed mode, and the value of the fixed_depth attribute may then be used as the offset value for the data broadcast.

Furthermore, when the display mode for the 3D video is the LL display mode (2D display), and the display mode for the data broadcast is the LR display mode (3D display), the offset acquirer 207 may forcibly set the offset value to zero.

Regardless of whether the user has a standing preference for displaying 3D video data in 2D, the data broadcast is unlikely to require 3D display. Thus, when the 3D video data are displayed in 2D, the offset value may be forcibly set to zero and the data broadcast may also be displayed in 2D.

(11) The flowchart of FIG. 16, explained for the above-described Embodiment, may be modified as follows.

When GOPs storing offset information and GOPs not storing offset information are received in alternation, the result of step S203 alternates between YES and NO. As a result, the offset value often changes, which likely makes the data broadcast extremely difficult to see. Accordingly, when the result of step S203 is NO, the offset value of the offset_sequence field stored in the GOP received in a predefined earlier interval may continue to be used, rather than immediately proceeding to step S208.

Also, when the value of the offset_sequence field corresponding to a given offset_sequence_id attribute greatly varies between GOPs, the data broadcast may be extremely difficult to view. Thus, when the value of the offset_sequence field corresponding to a given offset_sequence_id attribute has been detected as greatly varying between GOPs, step S204 of making the value of the offset_sequence field into the offset value may be cancelled and control may be switched such that the value of the fixed_depth attribute stored in the BML is used as the offset value.

Also, when the value of the fixed_depth attribute is made into the offset value, the process of steps S205 through S207 uses the offset information to verify that no interference occurs between 3D objects in the 3D video data and objects in the data broadcast. The value of the fixed_depth attribute is likely to have been preset to a large value. As such, any interference that occurs, if any, is likely to be weak. Therefore, steps S205 through S207 are not necessary and may be omitted. When the determination in step S201 reveals that the offset mode is fixed (YES in step S201), then steps S205 through S207 may be omitted and the process may immediately advance to step S208, using the value of the fixed_depth attribute stored in the BML as the offset value.

(12) In the above-described Embodiment, the video processing device 21 is configured to display the data broadcast in 3D. However, the video processing device 21 may also display subtitle data in 3D, rather than displaying the data broadcast.
(13) No particular limitation is intended regarding the transmission network between the broadcasting device 10 and the video processing device 21 being a digital broadcasting network. For example, the Internet may be used. In such circumstances, the broadcasting device 10 may be a server device on the Internet, and the video processing device 21 may be a personal computer.
(14) The video processing device 21 may be configured to receive a plurality of digital streams and to simultaneously display a plurality of programs on the display 22. In such circumstances, the offset acquirer 207 may acquire respective offset information for the digital streams and use this offset information to perform the offset value acquisition process.

For example, the offset acquirer 207 reads the value in the offset_sequence_id field of the base_depth element in the BML. Further, the offset acquirer 207 acquires the value of the offset_sequence field associated with the value of the offset_sequence_id attribute from all of the offset information. The offset acquirer 207 then takes the greatest value among the values of the offset_sequence fields so acquired as the offset value.

(15) The BML 18 explained with reference to FIG. 7 in the above-described Embodiment is an example. The structure of the BML used by the stereoscopic video viewing system 1 is, of course, not limited to the example of FIG. 7. For example, when a plurality of objects are described with common BML, a body element may store the base_depth element for each object.
(16) The data broadcast display process, the display mode setting process, and the offset value acquisition process explained in the above-described Embodiment may each be realized as a control program for execution by the processor of the video processing device 21, or by various circuits connected thereto, written in machine code or in a high-level programming language. The control program may be distributed by recording on a recording medium or by transport over various types of communication lines. The recording medium may be an IC card, a hard disk, an optical disc, a floppy disc, ROM, flash memory, or the like. The control program so transported and distributed may be provided for use by storage in memory that is read by a processor, such that the processor executes the functions explained in the above-described Embodiment by executing the control program. The processor may directly execute the program, may compile the program for execution, or may execute the program through an interpreter.
(17) The functional components of the above-described Embodiment (i.e., the program content repository 101, the offset information generator 102, the encoder 103, the data broadcast producer 104, the multiplexer 105, the broadcast stream transmitter 106, the demultiplexer 201, the audio decoder 202, the video decoder 203, the left-view video data output 204, the right-view video data output 205, the data broadcast processor 206, the offset acquirer 207, the right-view data broadcast image generator 208, the left-view data broadcast image generator 209, the left-view image generator 210, the right-view image generator 211, the display controller 212, the user input receiver 213, the display mode memory 214, the display mode switcher 215, and the offset mode memory 216) may be realized as circuits executing the respective functions, or may be realized one or more programs executed by a processor. Also, the device may realized as an IC, an LSI, or some other integrated circuit package. The package may be provided as embedded in some type of device, such that the device executes the functions described in the Embodiment.
(18) The above-described Embodiment may be freely combined with the above variations.

### (5. Supplement)

The configuration, variations, and effects of a video processing device, transmission device, and stereoscopic video viewing system are described below as a further Embodiment of the present invention.

A video processing device receives a data broadcast and video data for 3D display, and overlays, for output, an image of the data broadcast on a video of the video data, the video data including depth information that indicates a display depth for the image of the data broadcast when displayed in 3D, the depth information being set according to a depth at which an object based on the video data is displayed in 3D, the video processing device comprising: an acquirer acquiring the display depth from the depth information included in the video data; and a generator generating a right-view image and a left-view image for displaying the image of the data broadcast in 3D at the display depth acquired by the acquirer.

According to this configuration, the video processing device is able to display the data broadcast images overlaid on the video data at a depth corresponding to the depth of 3D objects in the video data. Thus, the user is able to more comfortably view the data broadcast along with the 3D video.

In this video processing device, the depth information lists a plurality of display depths for the image of the data broadcast when displayed in 3D for each of a plurality of display positions, the display depths being set according to the depth and the display position at which the object is displayed in 3D, the data broadcast includes position information indicating a display position for the image of the data broadcast, and the acquirer acquires the position information from the data broadcast, and acquires, from the depth information, the display depth corresponding to the display position indicated in the position information so acquired.

A plurality of 3D objects at different depths may be included in a single frame of the video data. Thus, according to the above configuration, the data broadcast images are constantly displayed in 3D at an appropriate depth corresponding to the depth of the 3D objects being commonly displayed at the same display position.

Also, for each display position listed in the depth information, the display depth for the image is set to a greater value than the depth at which the object is displayed in 3D for the display position, and when the image of the data broadcast is displayed in 3D, the image is viewed in front of the depth at which the object is displayed in 3D.

When images from a data broadcast are displayed behind a 3D object included in the video data, the resulting video may be perceived as unnatural by the user. Also, when the imaging position for the 3D object included in the video data and the imaging position for the data broadcast image overlap, and interference occurs between the 3D object and the data broadcast image, then the resulting image may be difficult for the user to view.

Thus, according to the above configuration, the data broadcast is displayed in front of the 3D object, enabling an image to be supplied that is easier for the user to view.

Further, the video data are distributed as a data stream in MPEG2-TS format, the data stream including the depth information in predetermined units, the acquirer sequentially acquires the display depth from the depth information included in the predetermined units of the data stream, and the generator generates the right-view image and the left-view image upon each acquisition of the display depth by the acquirer.

Although the content of the program on which the data broadcast is intended to be overlaid is knowable at data broadcast authoring time, it may be difficult to know details regarding the depth of 3D objects included in the program. Also, although the depth, based on broad predictions, for displaying the data broadcast images in 3D may be stored in the BML in advance at data broadcast authoring time, the depth of the 3D objects in the program may change over time. Thus, using the predetermined depth stored in the BML to display the data broadcast in 3D may not always result in appropriate depth for the data broadcast images displayed in 3D, due to the relationship thereof with the content of the program being simultaneously broadcast.

Thus, according to the above configuration, the depth information is included with predetermined units of the data stream, enabling 3D display of the data broadcast image at an appropriate depth corresponding to changes to the depth of the 3D object occurring over time.

In addition, the data broadcast includes fixed_depth information indicating a fixed display depth for the image of the data broadcast when displayed in 3D, the video processing device includes a data broadcast display selector selecting one of a fixed mode, in which the image of the data broadcast is displayed in 3D at the fixed display depth, and a variable mode, in which the image of the data broadcast is displayed in 3D at a display depth that varies according to variations in the depth at which the object in the video data on which the image is overlaid is displayed in 3D, and when the variable mode has been selected, the acquirer acquires the display depth from the depth information, and when the fixed mode has been selected, the acquirer acquires the display depth from the fixed_depth information included in the data broadcast, rather than acquiring the display depth from the depth information.

As described above, depth information included in the video data is used to enable 3D display of the data broadcast image at a depth corresponding to the depth of 3D objects in the video data. However, when the depth of the data broadcast image changes frequently, text and the like may be difficult to view.

According to the above configuration, when the fixed mode has been selected, the video processing device is able to display the data broadcast image in 3D at a fixed_depth.

Furthermore, the data broadcast display selector receives a selection of one of the fixed mode and the variable mode from a user.

Individual users likely have differences in screen perception. According to the above configuration, the data broadcast image is displayed as best suited to each user.

The data broadcast display selection unit corresponds to the user input receiver 213 and the offset mode memory 216 of the above-described Embodiment.

Further still, the video processing device has a function of displaying the video data for 3D display received thereby in 2D, and further comprises a display mode selector selecting one of a 3D mode, in which the video data for 3D display are displayed in 3D, and a 2D mode, in which the video data are displayed in 2D, wherein when the display mode selector has selected the 2D mode, the data broadcast display selector selects the fixed mode.

The video processing device may be configured to display a 3D program received from the broadcast device as a pseudo-2D program. In such circumstances, although the received 3D program includes depth information, varying the data broadcast image according to the depth of objects in the 3D program makes the data broadcast even harder for the user to view.

According to the above configuration, when the video data are displayed in 2D, the data broadcast is prevented from becoming difficult to view by displaying the data broadcast image at a fixed_depth.

Additionally, the display mode selector selects the 2D mode when the data broadcast does not include the position information and the fixed_depth information.

When the data broadcast does not include position information or fixed depth information, then the acquisition unit is unable to acquire the depth, and the generation unit is unable to generate the left-view image and the right-view image. Accordingly, the data broadcast is highly likely to be displayed in 2D.

As described above, when the data broadcast is displayed in 2D and overlaid on the 3D video data, the resulting image is difficult for the user to view. According to the above configuration, when there is a high probability that the data broadcast is to be displayed in 2D, display of an image that is difficult to view is prevented by displaying the 3D program received from the broadcast device as a pseudo-2D program.

Still further, the display mode selector receives a selection of one of the 3D mode and the 2D mode from a user.

The video processing device may be configured to display a 3D program received from the broadcast device as a pseudo-2D program. As such, according to this configuration, the user is able to view images displayed as preferred.

The display mode selection unit corresponds to the user input reception unit 213, the display mode memory 214, and the display mode switcher 215.

A transmission device transmitting a data broadcast and video data for 3D display, comprising: a memory storing the video data; a depth information generator generating depth information according to a depth at which an object is displayed in 3D based on the video data, the depth information indicating a display depth for an image of the data broadcast when displayed in 3D, and a transmitter transmitting the data broadcast and the video data including the depth information so generated.

According to this configuration, the transmission device is able to display the data broadcast images overlaid on the video data on the destination video processing device at a depth corresponding to the depth of 3D objects in the video data. Thus, the user is able to more comfortably view the data broadcast along with the 3D video.

A stereoscopic video viewing system includes a transmission device and a video processing device, the stereoscopic video viewing system overlaying and displaying an image of a data broadcast on video data for 3D display, wherein the transmission device comprises: a memory storing the video data; a depth information generator generating depth information according to a depth at which an object is displayed in 3D based on the video data, the depth information indicating a display depth for the image of the data broadcast when displayed in 3D; and a transmitter transmitting the data broadcast and the video data including the depth information so generated; and the video processing device comprises: a receiver receiving the data broadcast and the video data including the depth information; an acquirer acquiring the display depth from the depth information included in the video data; and a generator generating a right-view image and a left-view image for displaying the image of the data broadcast in 3D at the display depth acquired by the acquirer.

According to this configuration, the video processing device is able to display the data broadcast images overlaid on the video data at a depth corresponding to the depth of 3D objects in the video data. Thus, the user is able to more comfortably view the data broadcast along with the 3D video.

### INDUSTRIAL APPLICABILITY

The video processing device that is one aspect of the present invention is applicable to the manufacture and sale of a video processing device capable of playing back 3D video data and a data broadcast, and to technology enabling the data broadcast to be displayed in 3D in such a way that the resulting images are easy for the user to view.

### REFERENCE SIGNS LIST

1 Stereoscopic video viewing system
10 Broadcasting device
20 Digital television
21 Video processing device
22 Display
30 Remote control
40 3D glasses
101 Program content repository
102 Offset information generator
103 Encoder
104 Data broadcast producer
105 Multiplexer
106 Broadcast stream transmitter
201 Demultiplexer
202 Audio decoder
203 Video decoder
204 Left-view video data output
205 Right-view video data output
206 Data broadcast processor
207 Offset acquirer
208 Right-view data broadcast image generator
209 Left-view data broadcast image generator
210 Left-view image generator
211 Right-view image generator
212 Display controller
213 User input receiver
214 Display mode memory
215 Display mode switcher
216 Offset mode memory

1. A video processing device receiving a data broadcast and video data for 3D display, and overlaying, for output, an image of the data broadcast on a video of the video data,
the video data including depth information that indicates a display depth for the image of the data broadcast when displayed in 3D, the depth information being set according to a depth at which an object based on the video data is displayed in 3D, the video processing device comprising:
an acquirer acquiring the display depth from the depth information included in the video data; and
a generator generating a right-view image and a left-view image for displaying the image of the data broadcast in 3D at the display depth acquired by the acquirer.

2. The video processing device of claim 1, wherein
the depth information lists a plurality of display depths for the image of the data broadcast when displayed in 3D for each of a plurality of display positions, the display depths being set according to the depth and the display position at which the object is displayed in 3D,
the data broadcast includes position information indicating a display position for the image of the data broadcast, and
the acquirer acquires the position information from the data broadcast, and acquires, from the depth information, the display depth corresponding to the display position indicated in the position information so acquired.

3. The video processing device of claim 2, wherein
for each display position listed in the depth information, the display depth for the image is set to a greater value than the depth at which the object is displayed in 3D for the display position, and
when the image of the data broadcast is displayed in 3D, the image is viewed in front of the depth at which the object is displayed in 3D.

4. The video processing system of claim 3, wherein
the video data are distributed as a data stream in MPEG2-TS format, the data stream including the depth information in predetermined units,
the acquirer sequentially acquires the display depth from the depth information included in the predetermined units of the data stream, and
the generator generates the right-view image and the left-view image upon each acquisition of the display depth by the acquirer.

5. The video processing device of claim 2, wherein
the data broadcast includes fixed_depth information indicating a fixed display depth for the image of the data broadcast when displayed in 3D,
the video processing device includes a data broadcast display selector selecting one of a fixed mode, in which the image of the data broadcast is displayed in 3D at the fixed display depth, and a variable mode, in which the image of the data broadcast is displayed in 3D at a display depth that varies according to variations in the depth at which the object in the video data on which the image is overlaid is displayed in 3D, and
when the variable mode has been selected, the acquirer acquires the display depth from the depth information, and when the fixed mode has been selected, the acquirer acquires the display depth from the fixed_depth information included in the data broadcast, rather than acquiring the display depth from the depth information.

6. The video processing device of claim 5, wherein
the data broadcast display selector receives a selection of one of the fixed mode and the variable mode from a user.

7. The video processing device of claim 5, having a function of displaying the video data for 3D display received thereby in 2D, further comprising
a display mode selector selecting one of a 3D mode, in which the video data for 3D display are displayed in 3D, and a 2D mode, in which the video data are displayed in 2D, wherein
when the display mode selector has selected the 2D mode, the data broadcast display selector selects the fixed mode.

8. The video processing device of claim 7, wherein
the display mode selector selects the 2D mode when the data broadcast does not include the position information and the fixed_depth information.

9. The video processing device of claim 7, wherein
the display mode selector receives a selection of one of the 3D mode and the 2D mode from a user.

10. A transmission device transmitting a data broadcast and video data for 3D display, comprising:
a memory storing the video data;
a depth information generator generating depth information according to a depth at which an object is displayed in 3D based on the video data, the depth information indicating a display depth for an image of the data broadcast when displayed in 3D, and
a transmitter transmitting the data broadcast and the video data including the depth information so generated.

11. A stereoscopic video viewing system that includes a transmission device and a video processing device, the stereoscopic video viewing system overlaying and displaying an image of a data broadcast on video data for 3D display, wherein
the transmission device comprises:
a memory storing the video data;
a depth information generator generating depth information according to a depth at which an object is displayed in 3D based on the video data, the depth information indicating a display depth for the image of the data broadcast when displayed in 3D; and
a transmitter transmitting the data broadcast and the video data including the depth information so generated; and
the video processing device comprises:
a receiver receiving the data broadcast and the video data including the depth information;
an acquirer acquiring the display depth from the depth information included in the video data; and
a generator generating a right-view image and a left-view image for displaying the image of the data broadcast in 3D at the display depth acquired by the acquirer.

12. A video processing method used by a video processing device receiving a data broadcast and video data for 3D display, and overlaying, for output, an image of the data broadcast on a video of the video data,
the video data including depth information that indicates a display depth for the image of the data broadcast when displayed in 3D, the depth information being set according to a depth at which an object based on the video data is displayed in 3D, the video processing method comprising:
an acquisition step of acquiring the display depth from the depth information included in the video data; and
a generation step of generating a right-view image and a left-view image for displaying the image of the data broadcast in 3D at the display depth acquired by the acquirer.

13. A video processing program executed by a video processing device receiving a data broadcast and video data for 3D display, and overlaying, for output, an image of the data broadcast on a video of the video data,
the video data including depth information that indicates a display depth for the image of the data broadcast when displayed in 3D, the depth information being set according to a depth at which an object based on the video data is displayed in 3D, the video processing program causing the video processing device to execute:
an acquisition step of acquiring the display depth from the depth information included in the video data; and
a generation step of generating a right-view image and a left-view image for displaying the image of the data broadcast in 3D at the display depth acquired by the acquirer.

14. An integrated circuit receiving a data broadcast and video data for 3D display, and overlaying, for output, an image of the data broadcast on a video of the video data,
the video data including depth information that indicates a display depth for the image of the data broadcast when displayed in 3D, the depth information being set according to a depth at which an object based on the video data is displayed in 3D, the integrated circuit comprising:
an acquirer acquiring the display depth from the depth information included in the video data; and
a generator generating a right-view image and a left-view image for displaying the image of the data broadcast in 3D at the display depth acquired by the acquirer.
